(19) United States
(12) Patent Application Publication
(10) Pub. No.: US 2004/0051727 A1
(43) Pub. Date: Mar. 18, 2004

(54) Display control method, information display device and medium

(76) Inventors: Hiroyuki Endo, Tokyo (JP); Masahiro Hamada, Hitachi-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/451,632

(22) PCT Filed: Jan. 10, 2002
(86) PCT No.: PCT/JP02/00077

(30) Foreign Application Priority Data
Jan. 10, 2001 (JP) 2001-002647

(51) Int. Cl. G09G 5/00

(52) U.S. Cl. 345/700

(57) ABSTRACT

In order to provide a display control technique that easily enables a high-visual-effect, dynamic display on a general-purpose information display screen without requiring complicated processing, an object as decorative operation information (e.g., drawing process information such as line drawing) displayed in multiple forms with respect to general-purpose original display information is defined by using the Internet such as HTML documents, and the object can be run in an image position in a high-order hierarchy multi-layered on the original display information.

### TECHNICAL FIELD

The present invention relates to a display technique used in delivering a presentation or the like with the use of a personal computer.

### BACKGROUND ART

HTML (Hyper Text Mark-up Language) is known as a content display format on the Internet. In an HTML format source file, a tag can control output of document, voice, a still image or a moving image, so that a presentation is often delivered by using this document format.

However, in a case where this HTML-format document is used to deliver a dynamic presentation, for example, a marker line is drawn or a circle is drawn around a keyword on the display screen, it was necessary to use a special language such as JAVA, or a specialized authoring program.

For example, as a technique for regenerating the drawing process, there is an object program referred to as “VML Render” which is provided by Microsoft Cooperation. This program uses a specified object tag defined within HTML to draw a single line in a single color, in which JAVA script included on HTML and other document data where data is written are synchronized with external time information to draw a polyline composed of a group of coordinates of points to be drawn.

However, the above-mentioned conventional technique relies on a specific browser program. Thus, it cannot be said that the program is a general-purpose program.

The present invention has been created in light of these points, and has a technical object to provide a display control technique that easily enables a high-visual-effect dynamic display on a general-purpose information display screen without requiring complicated processing.

### DISCLOSURE OF THE INVENTION

In the present invention, an object as decorative operation information (for example, drawing process information such as line drawing) displayed in multiple forms with respect to general-purpose original display information is defined by using the Internet such as HTMEL documents, and this object can be run in an image position in a high-order hierarchy multi-layered on the original display information. This high-order hierarchy image is defined in a transparent color or defined as a so-called laminate image, and the above-mentioned object is executed on the laminate image.

That is, the content creator reads the existing HTML document or the like or creates one anew, and arranges the objects while confirming them on the screen, without being aware of the above-mentioned laminate structure. At this time, the type, shape, display coordinates, and the like of the arranged objects are stored in the object storage table.

Further, in a case of the object which reproduces the process of the drawing on the transparent laminate screen, when the lines are freely drawn using the input coordinate device such as a mouse or a stylus pen, the drawings on the laminate are constantly stored into the freehand line drawing storage table, based on the inputted coordinates.

Further, in order that these objects effectively decorate the HTML document or other characters and the objects placed on the HTML document, etc., the content creator performs setting so that they appear, disappear, start operation, stop operation, and restart operation according to a duration of time elapsing after the HTML document is displayed, or according to reproduction time of the other objects having time axis, such as the moving image or voice, or in response to events such as the mouse click or mouse-in on the other arranged objects. All the scenarios which have been set are stored in the object operation definition table.

When the content creation is finished, the object storage table, the freehand line drawing storage table, the object operation definition table, etc., which have been stored as the tables, are stored as one operation scenario in a storage medium such as a hard disk.

At the time when the user is to view the content created in this way, the scenario data saved on the above-mentioned hard disk or other such storage medium is automatically read, the object storage table, the freehand line drawing storage table, the object operation definition table and the like are opened up, and the reproduction is performed according to the content of these tables, whereby the content can be viewed as intended by the content creator.

### BRIEF DESCRIPTION OF THE DRAWINGS

FIG. 1 is a conceptual diagram of the present invention.

FIG. 2 is a block diagram showing an editing procedure at the time of content creation.

FIG. 3 is a diagram showing a construction of an object operation scenario definition table.

FIG. 4 is a diagram showing a construction of a freehand line drawing object storage table.

FIG. 5 is a diagram showing content of operation scenario data.

FIG. 6 is a flow chart showing a procedure at the time of content reproduction.

FIG. 7 is a flow chart showing an operation procedure of an event monitoring module.

FIG. 8 is a flow chart showing an operation procedure of an elapsed time monitoring module.

FIG. 9 is a flow chart showing an operation procedure of an operation/voice reproduction time monitoring module.

FIG. 10 is a flow chart showing a drawing processing procedure of an object that reproduces a drawing process.

FIG. 11 is a block diagram of functions at the time of content reproduction.

FIG. 12 is a screen diagram showing an object insertion example (1).

FIG. 13 is a screen diagram showing an object insertion example (2).

FIG. 14 is a screen diagram showing an object insertion example (3).

FIG. 15 is a screen diagram showing an object insertion example (4).

FIG. 16 is a screen diagram showing an object insertion example (5).

FIG. 17 is a screen diagram showing an object insertion example (6).

FIG. 18 is a screen diagram showing an object insertion example (7).

FIG. 19 shows an interface screen for linking an event to an object (1).

FIG. 20 shows an interface screen for linking an event to an object (2).

FIG. 21 shows an interface screen for linking an event to an object (3).

FIG. 22 shows an interface screen for linking an event to an object (4).

FIG. 23 shows an interface screen using a time axis (1).

FIG. 24 shows an interface screen using a time axis (2).

FIG. 25 shows an interface screen using a time axis (3).

FIG. 26 shows an interface screen using a time axis (4).

### BEST MODE FOR CARRYING OUT THE INVENTION

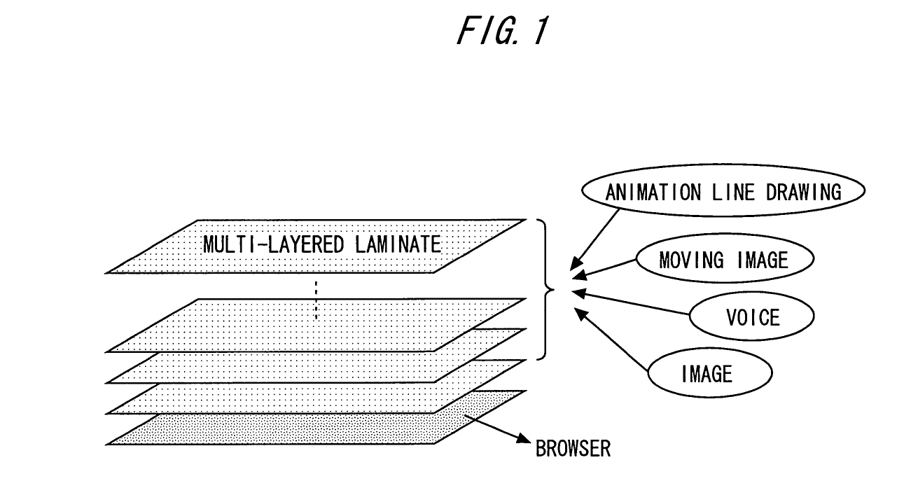

FIG. 1 illustrates a concept of the present invention. As shown in the diagram, in the present invention, a still image, a moving image, voice, or other such multimedia object made using a conventional technique or an “object reproducing a drawing process on a transparent laminate” according to the present invention is inserted on layered laminates with a transparent background with respect to an existing or newly created HTML document or other such document that can be displayed with a browser program, according to an instruction from a content creator.

Here, as the browser program, there can be used Internet Explorer by Microsoft Cooperation, Netscape by Netscape, Inc., or other such general-purpose browser program.

The browser program, and a program constituting the main part of the present invention, run on an OS (operating system) installed in a general-purpose computer. For the operating system, Windows 3.1, Windows 95, Windows NT, Windows 98, Windows 2000, Windows ME or UNIX, LINUX or any other program may be used.

Hardware constituting the computer includes a main memory, a memory constituted of RAM, ROM, etc., a hard disk device and other such supplementary storage devices, an external display and printer device and such external output devices, a keyboard and mouse and other such input devices, a communications device for connecting with the external Internet, and the like, which are connected by a bus centered around a central processing unit (CPU).

The content creator boots the OS, then loads the above-mentioned browser program, and can designate operations such as to appear, delete, start operation, stop operation and restart operation for display objects displayed by the browser program. Further, as needed, operation definitions for the objects can be set by combining operations of their own objects, in response to a click (an instruction input designating coordinates) by the mouse on another object arranged elsewhere or by mouse-in or other such event, or in response to time elapsed since starting reproduction of another arranged moving image or voice or other such object having a time axis.

Then, the operation definitions set for the objects are stored as scenario data in the hard disk device.

When a user is to view the above-mentioned content, the scenario data stored as mentioned above is automatically read from the hard disk device to the memory, and content reproduction according to the intention of the content creator is performed.

Further, the stored scenario data is automatically read out also at the time when the above-mentioned content creator is to edit content, and it is possible to add or delete an object, alter an operation of the object, and alter an event that is a cause for the operation to return to an original operation, and the like.

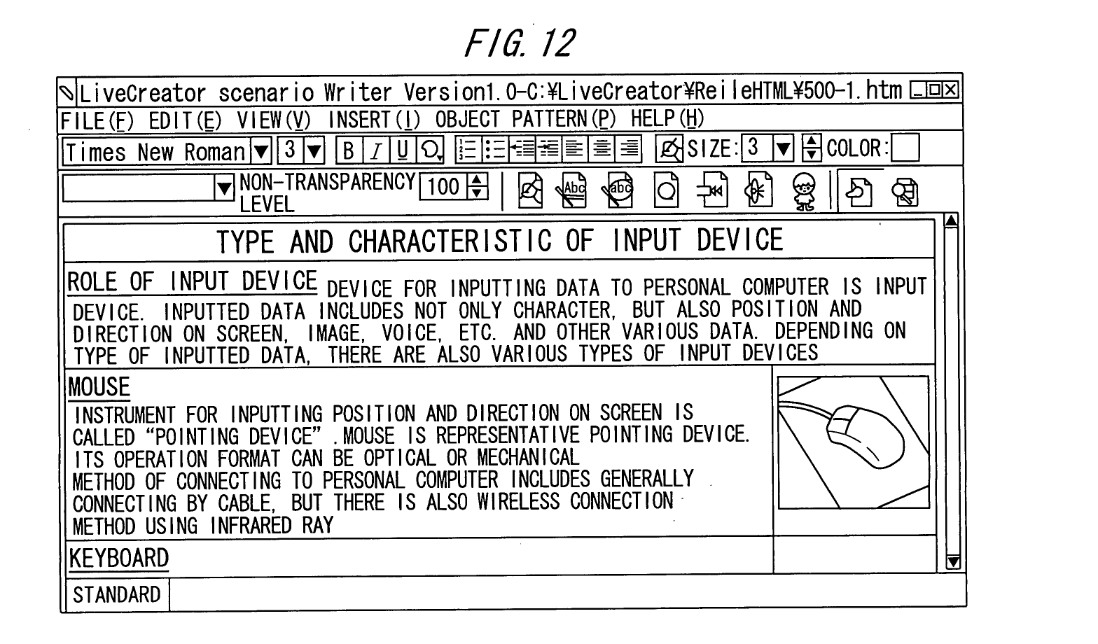

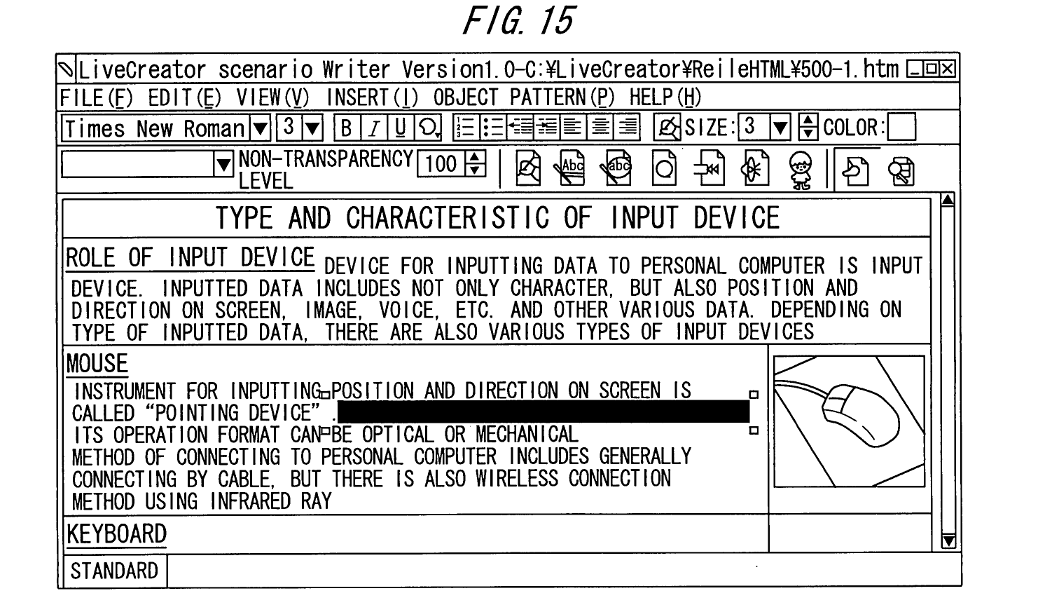

FIG. 12 through FIG. 15 illustrate examples of screen operations for registering the drawing process created by the content creator, as an object.

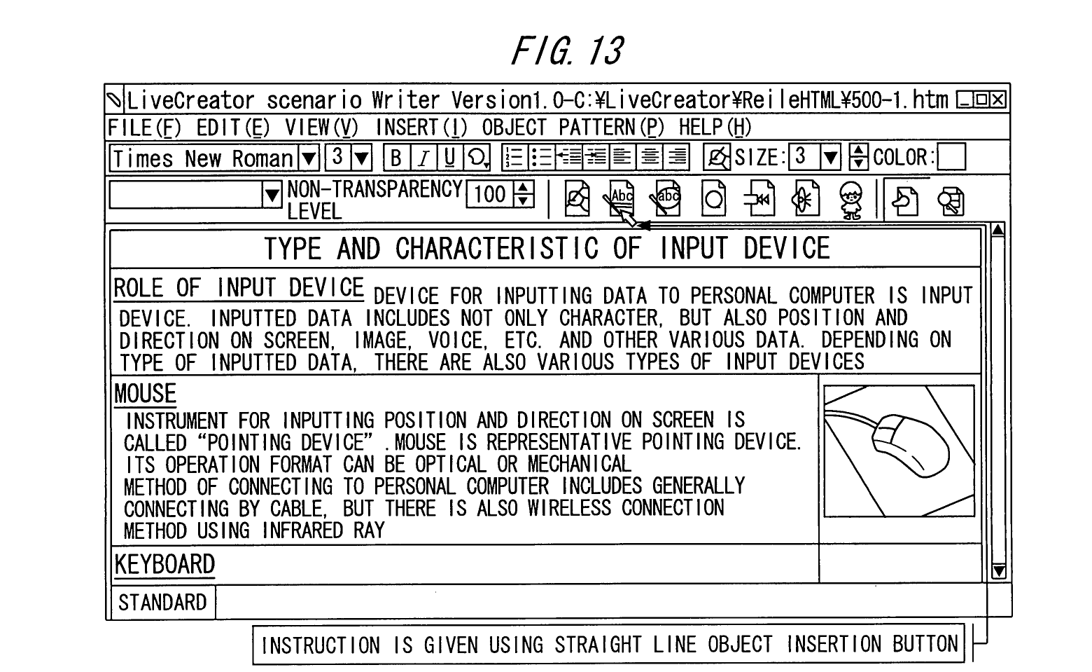

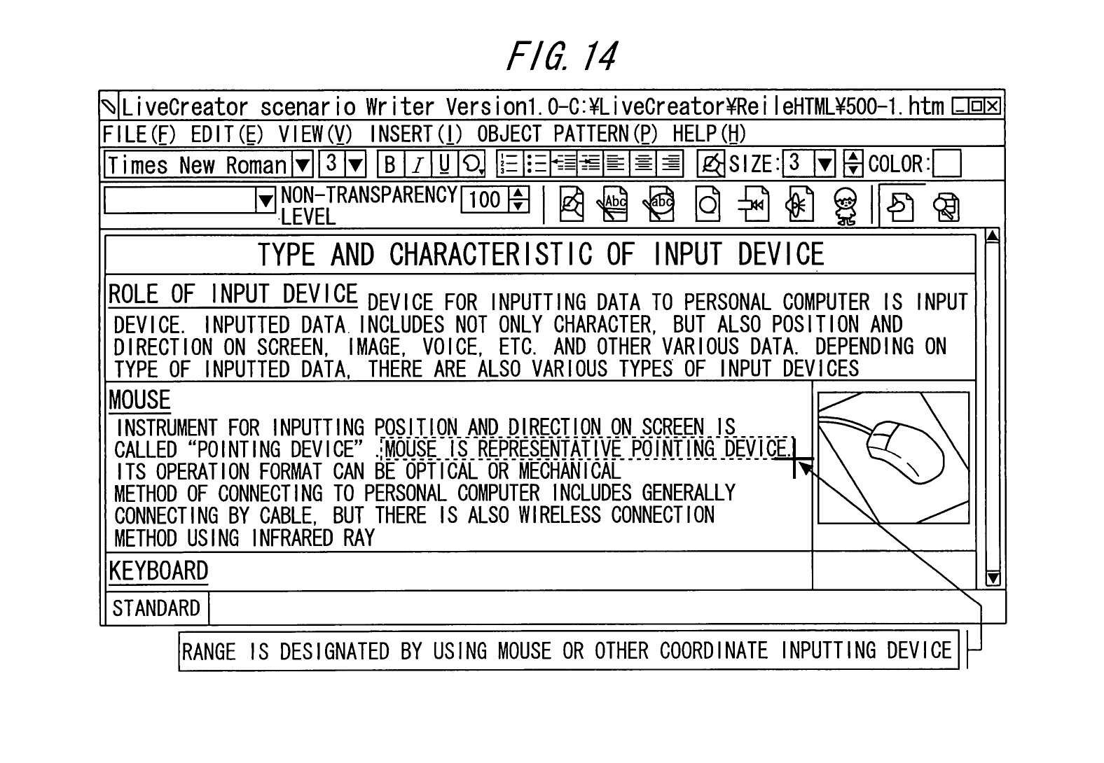

In FIG. 12, the HTML document is shown. In a case where a line is displayed with a marker at a particular place in the document, first, as shown in FIG. 13, a button indicating insertion of a linear object is pointed with a mouse. Next, as shown in FIG. 14, a range is indicated with the mouse at the place where the straight line object is to be inserted. Then, by releasing a drag button on the mouse, the straight line object is drawn as a marker at the given place in the document. In FIG. 14, a portion of the document is displayed within a black zone. This is shown on the display device of a user terminal, producing the same visual effect as a line drawn with a fluorescent marker on a portion of a printed document, for example.

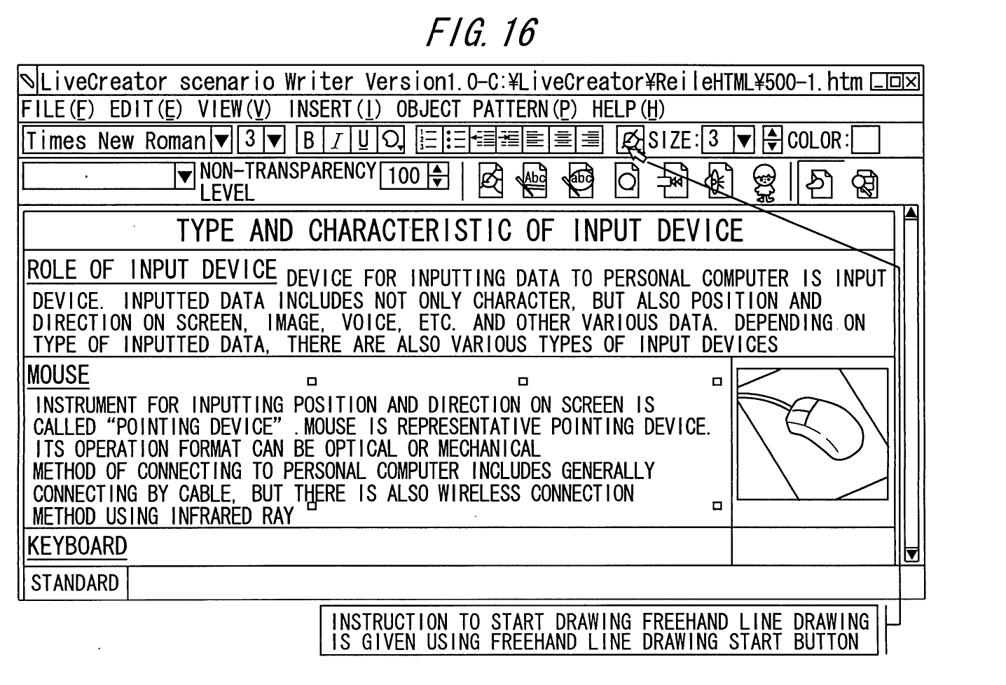

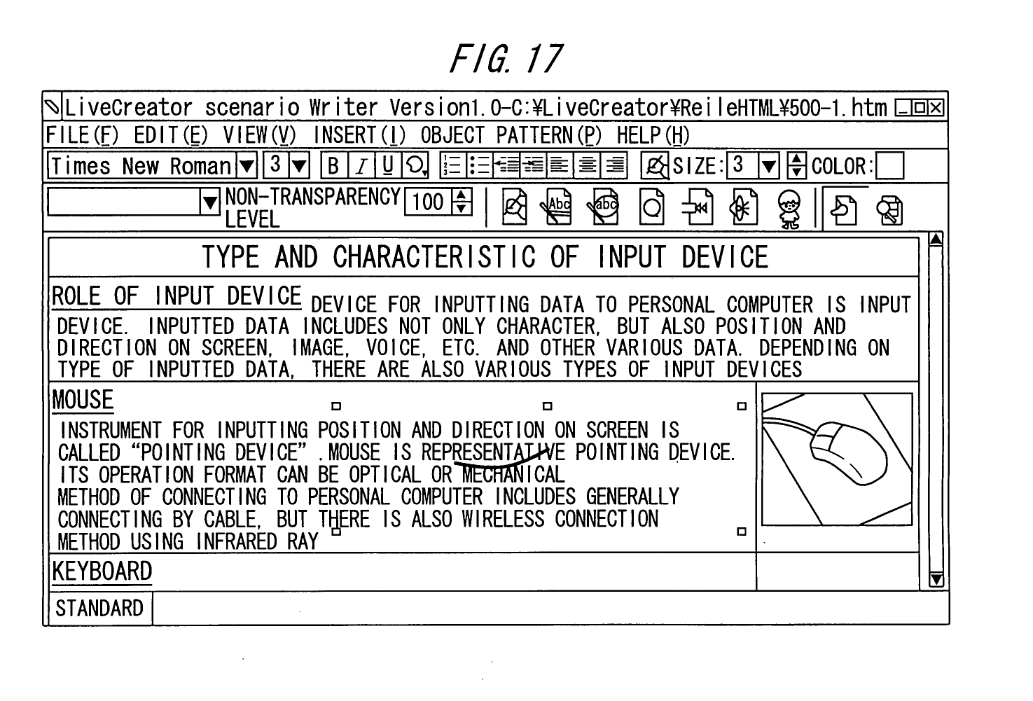

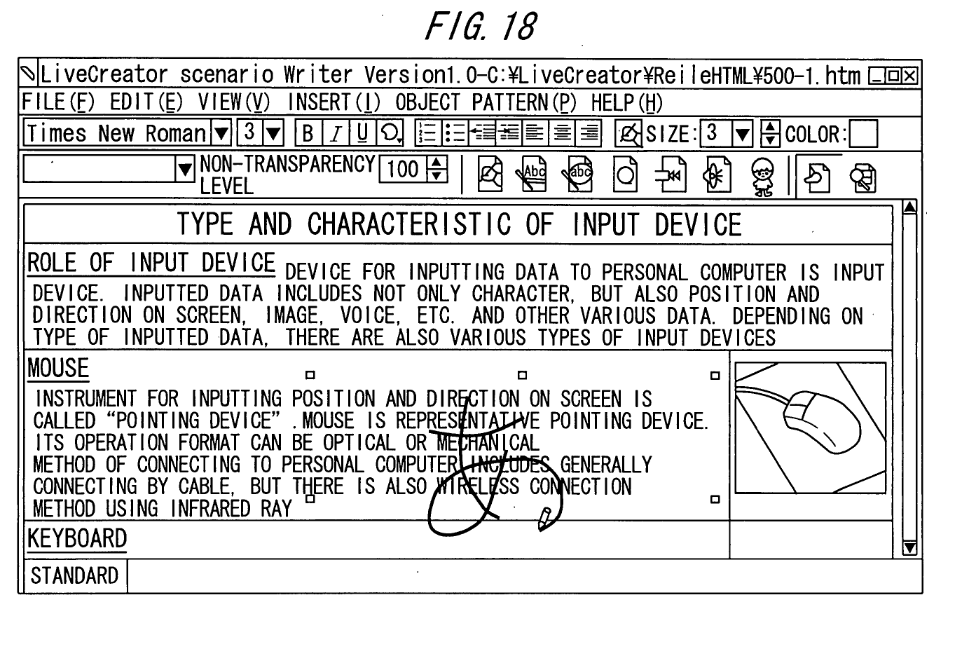

FIG. 16 through FIG. 18 illustrate a process of drawing a freehand line drawing (here the Japanese syllable “A”) on the HTML document in the same way using the mouse.

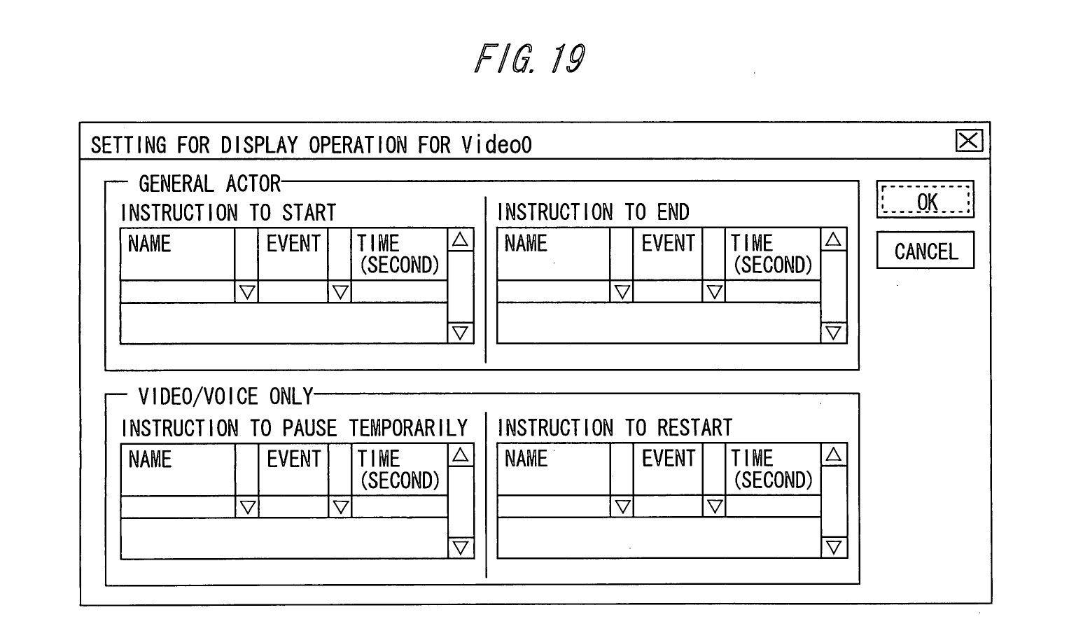

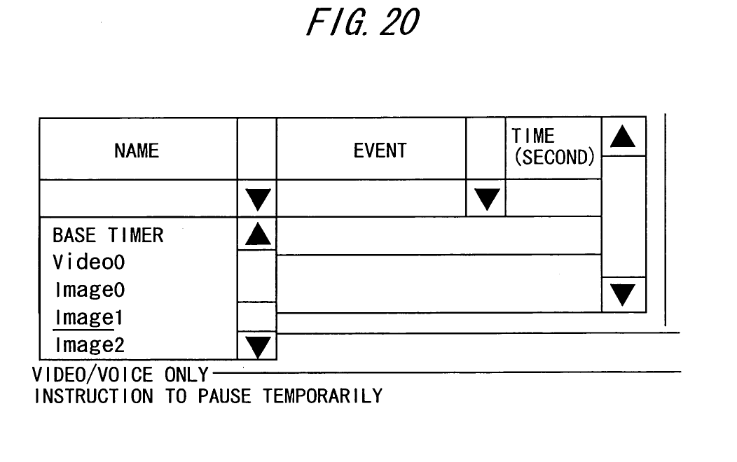

FIG. 19 through FIG. 22 illustrate an interface screen for giving operation instructions for linking the event to the object. Namely, after selecting the object for which the event is to be set, an item “Display Operation Settings” is selected from a pop-up menu displayed by a right-click on the mouse, causing the screen shown in FIG. 19 to be displayed. Here, a pull-down menu is used to select from name items the object that will receive an event (FIG. 20). The objects are defined as follows: in a case of video information, the object is video0; and in a case of image information, the object is image0. Further, a base timer defines how many seconds elapse after the HTML document is displayed until the object is loaded.

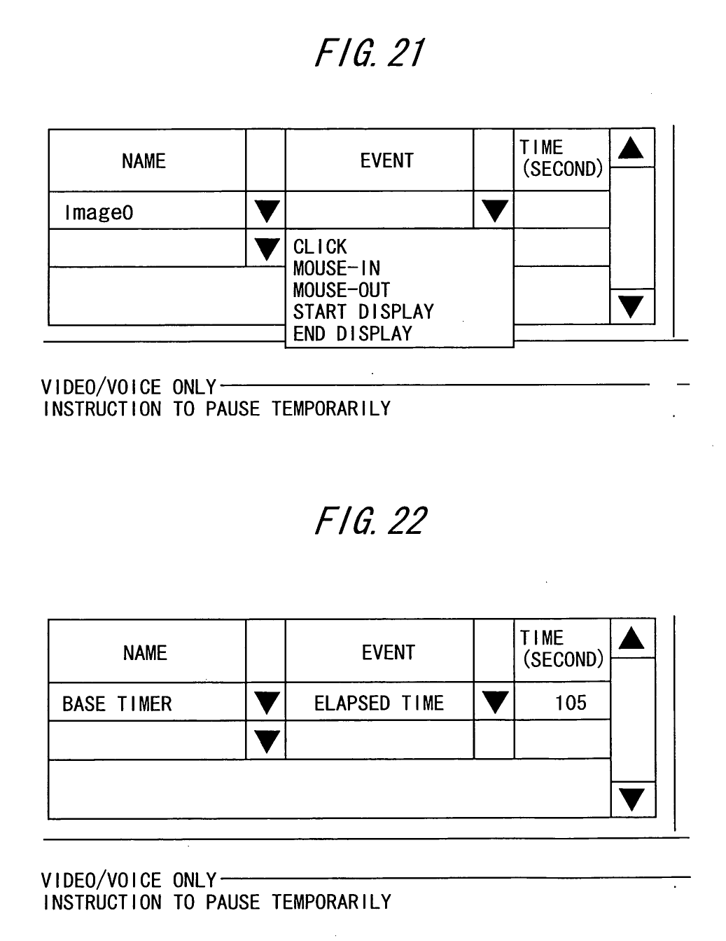

Next, the event is selected as shown in FIG. 21. Here, event content varies depending on an event source (event occurrence) object. For example, in the case of the moving image and the voice, events concerning stopping, restarting and time elapse are added. For example, as shown in FIG. 22, in a case where the event source object is the moving image, the voice or the base timer and the event is the elapse of time, a duration of time is designated in the time item.

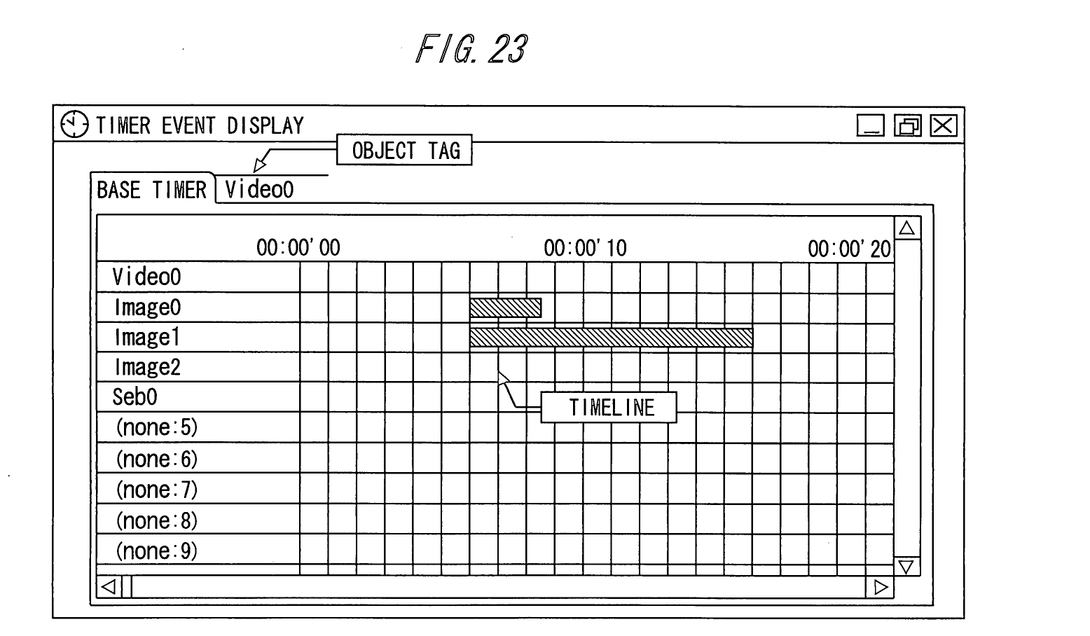

FIG. 23 through FIG. 26 are explanatory diagrams indicating operation instructions on an interface screen according to a time axis.

As shown in FIG. 23, a name of an object having a time axis is automatically added to an object tag, and synchronization timelines indicating display starting and display ending of other objects can be confirmed. In this window, another synchronization of display starting and display ending can be added, and the current synchronizations of display starting and display ending can be adjusted or deleted.

In a case where the time duration is adjusted, in the same drawing, the timeline which is to be adjusted is clicked with the mouse and is thus put in a selected state, and the selected timeline is dragged-and-dropped to alter the time duration. When this is performed, the shape of the cursor changes on the timeline that is in the selected state. Further, the cursor shape changes when the mouse is moved to the right edge or the left edge, so that the time duration can be altered through drag operation.

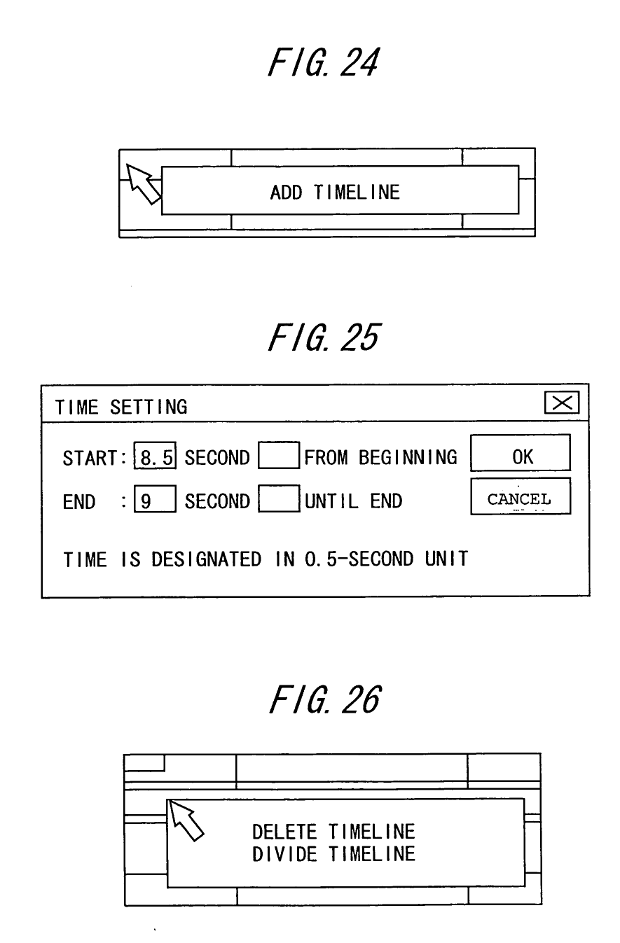

In order to add a timeline in an object to be added, a right-click is made at a place where there is no timeline, and thus a pop-up menu such as shown in FIG. 24 is displayed. Here, when this menu (“Add Timeline”) is selected, a dialogue box shown in FIG. 25 opens up. By inputting the items included in this dialogue box, the timeline is added.

In order to divide and delete the timeline, the mouse is right-clicked on the timeline which is to be divided or deleted, and a pop-up menu shown in FIG. 26 is displayed. With an item “Delete Timeline” of the menu, the timeline is deleted. Further, when “Divide Timeline” is selected, the timeline is divided at the position that was pointed to.

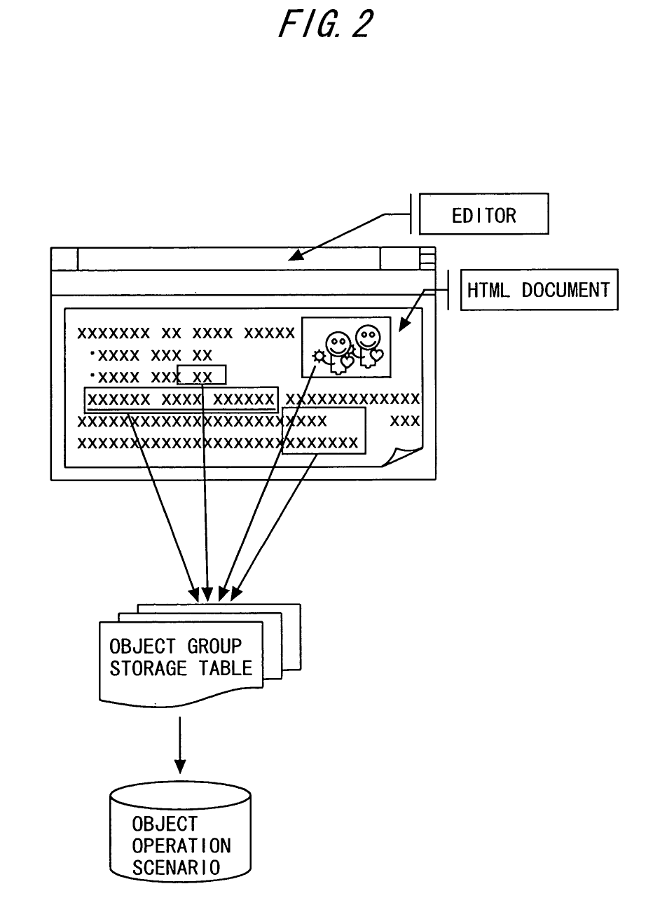

FIG. 2 shows an outline of a method of registering the scenario data created by the content creator.

An editor capable of editing HTML document, for example, a program such as Word available from Microsoft Cooperation, is loaded, and this editor is used to arrange the object in the HTML document. Type, shape, display coordinates and the like of the object are each linked to multi-layered laminate images on the screen of the browser shown in FIG. 1, and are saved in an object group storage table. Further, the object operation definitions of the object group are stored in the hard disk device as the object operation scenario data.

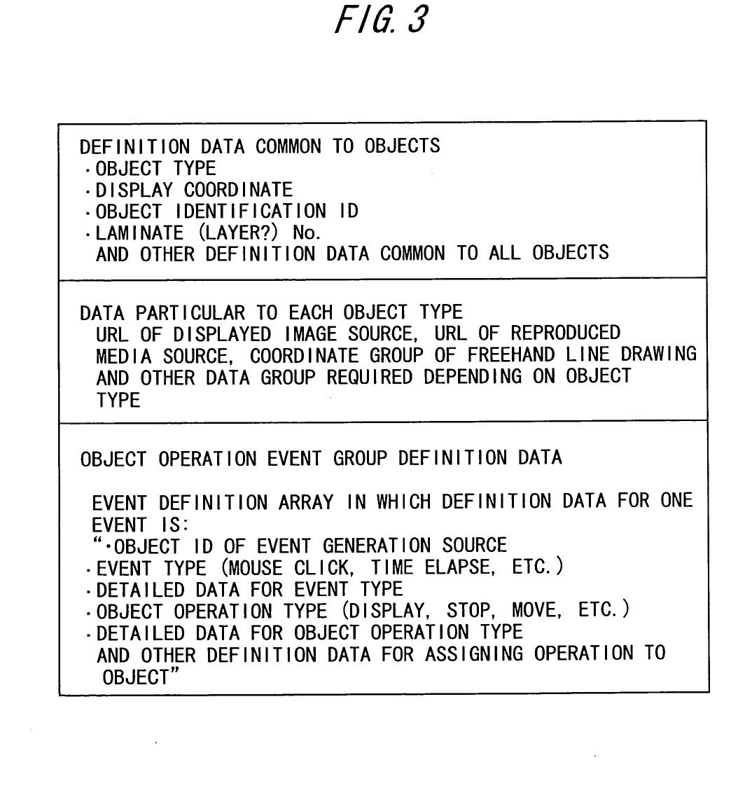

FIG. 3 shows a construction of the object group storage table stored in the hard disk device.

As shown in the diagram, this table is comprised of an object common table, an individual data table and an event group definition data table.

Specifically, information concerning video, voice, characters, straight lines, circles, freehand line drawings and the like, and object type (format), display coordinate, object identification ID, laminate No. (position in a multi-layered image) and the like are registered in the object common table. In other words, by referring to this table, it is possible to learn what kind of object is executed at which position in the multi-layered image.

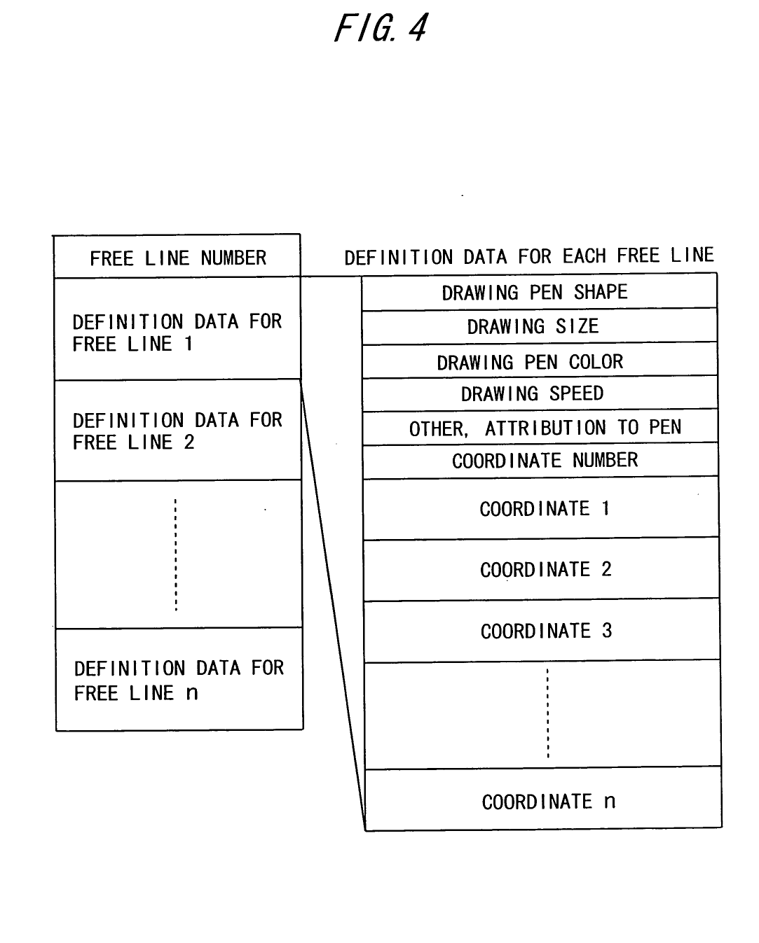

The individual data table stores individual information which varies depending on the object type, including an address indicating a location of an image source to be displayed, namely a URL (Uniform Resource Locator), a URL indicating a location of a media source to be reproduced, and a coordinate group of the freehand line drawing. Details of this individual table data are explained later using FIG. 4.

In the event group definition data table, there are registered an object ID of an event generation source, an event type (such as a mouse click or the elapse of time), and the like.

For example, as the object ID, a definition such as “video 0” is registered, and as the event type, information indicating that the event is executed when a mouse click occurs, or information indicating that the event is executed when a predetermined duration of time elapses, is registered.

FIG. 4 shows a construction of the freehand line drawing object storage table that is stored in the hard disk device.

The object storage table indicates the content itself of the “data table of individual data for each object type” in the “object operation scenario definitions table” in the case where the object type is the “freehand line drawing” in the above-mentioned object operation scenario definition table. This table is configured such that the definition data for each freehand line, for example, a drawing pen shape, a drawing pen size, a drawing pen color, a drawing speed, etc., and the coordinate values, are registered respectively.

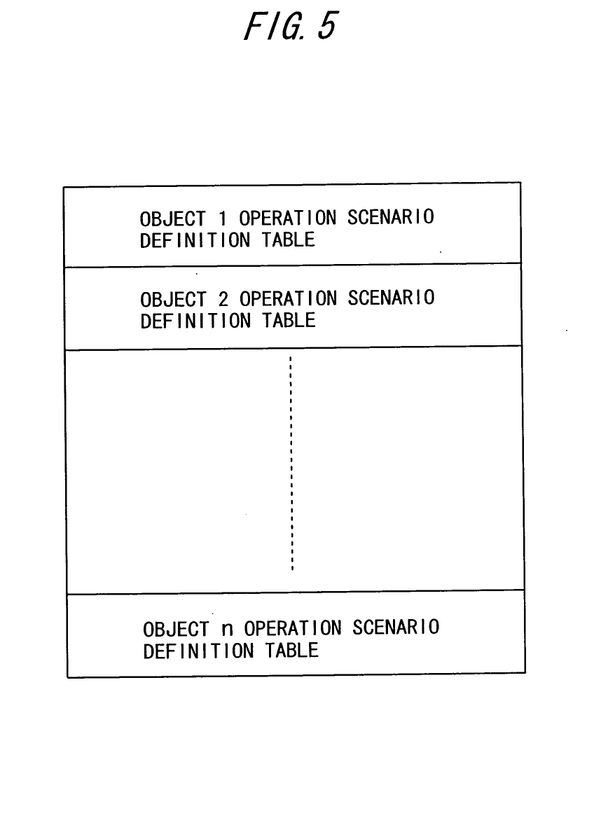

FIG. 5 shows a construction of an operation scenario stored in the hard disk device. As shown in the same diagram, this operation scenario is actually composed of a plurality of scenario definition tables explained with reference to FIG. 3.

In accordance with this embodiment, the central processing unit (CPU) reads sequentially the scenario definition tables according to this operation scenario data, and executes them in sequence. Further, this definition table corresponds to each layer image displayed in the display screen. For example, the object defined in an object 1 operation scenario definition table is executed on a first-layer screen, and an object defined in an object 2 operation scenario definition table is executed on a second-layer screen.

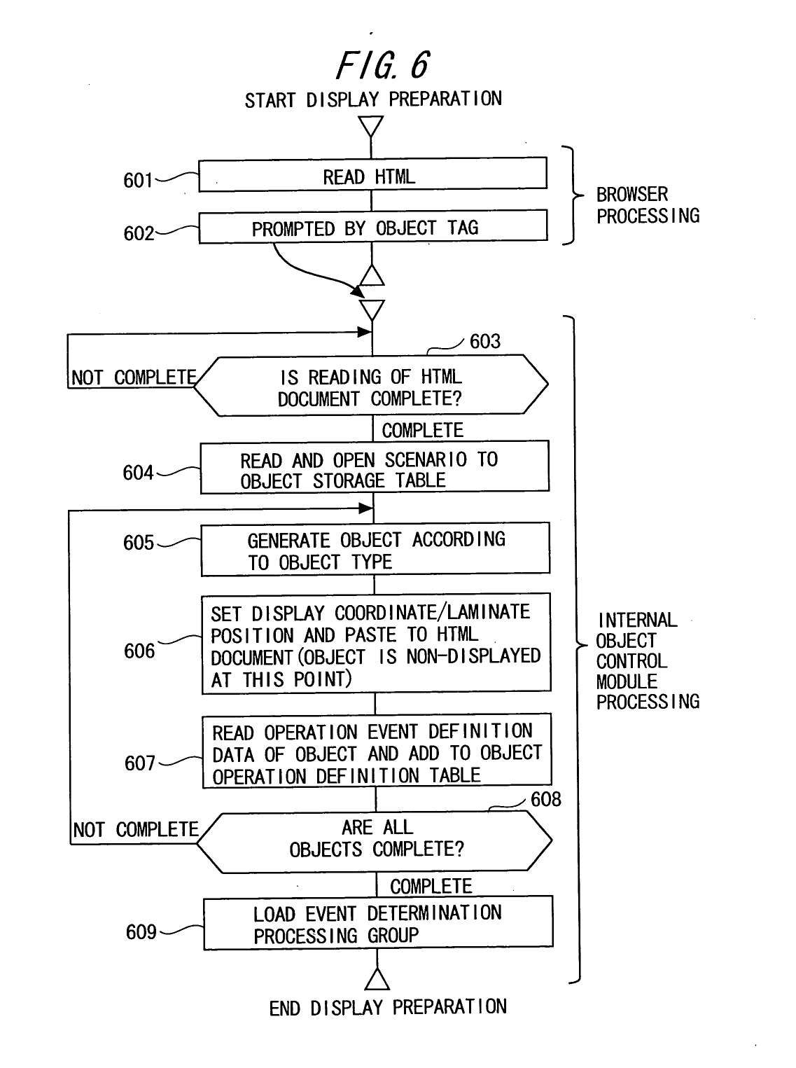

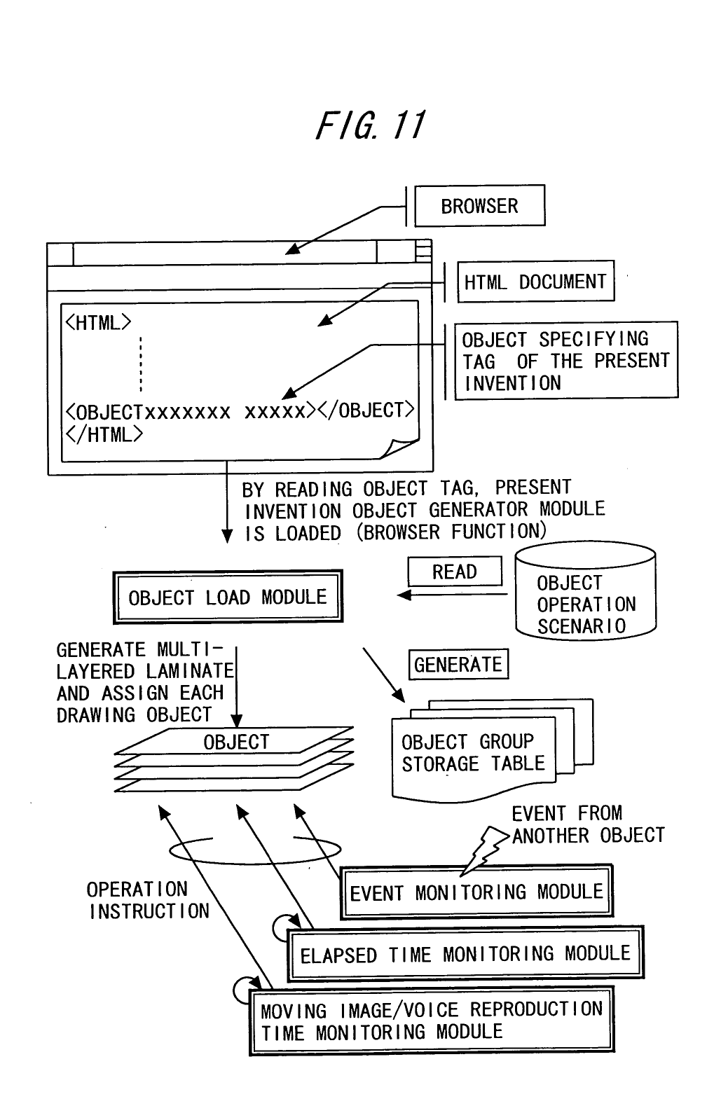

FIG. 6 is a flow chart showing a processing procedure for regenerating the object, and FIG. 11 is a functional block diagram showing each module operation at that time.

This object is run on the display device of the user terminal. Therefore, the hard disk device in the personal computer which constitutes the user terminal is installed with the object module and the object operation scenario in advance. The object module includes an object load module, various monitoring modules, and a control module which comprehensively controls these.

These modules and the operation scenario data may be downloaded from a server via the Internet, or may be distributed through the media such as CD-ROM and installed onto the user terminal which the user individually uses himself or herself.

The user operates the user terminal to specify a URL of a specific server, read the HTML source file registered at that URL to the memory, and display this HTML source file by means of the browser program.

Here, at the time when the HTML document is read and displayed on the browser program, when an object tag (a tag defined as <object>) in the description of the HTML document is discovered, the object load module stored in the hard disk device of the user terminal is loaded.

This object load module first reads the object operation scenario inside the hard disk device.

The object load module produces the multi-layered laminate image in sequence based on the operation scenario, and also produces the object group storage table inside the hard disk device of the user terminal.

The above-mentioned multi-layered laminate image is monitored by means of monitoring module such as an event monitoring module, an elapsed time monitoring module, or a moving image/voice reproduction time monitoring module in the above-mentioned monitoring module. Occurrence of a specific event, elapse of a specific duration of time, or reproduction of the moving image or voice, serves as a trigger, to designate the multi-layered laminate image, and execute the objects linked to each of these laminate images.

FIG. 6 illustrates this in a flow chart.

In FIG. 6, first, at the user terminal, the HTML document received by the browser program is loaded (step 601). Here, when the object tag is discovered, the discovery of the object tag is reported to the control module, and the object load module is loaded (602).

The object load module recognizes that the HTML document has been read completely (603), and the scenario data is opened to the object storage table according to the sequence set in the object operation scenario (604).

Here, when a new object type is discovered, the control module produces the object and registers it in the object group storage table (605).

Next, the control module sets the display coordinates and the layer position in the laminate image. At this time, the object is not yet displayed (606). Note that, at this time, each laminate image is made invisible.

Next, the object operation event group definition data explained in FIG. 3 is read out and is added to the object operation scenario definition table of FIG. 5.

In this way, when the object operation scenario definition table is completed for all the objects, each of the monitoring modules explained in FIG. 6 is loaded.

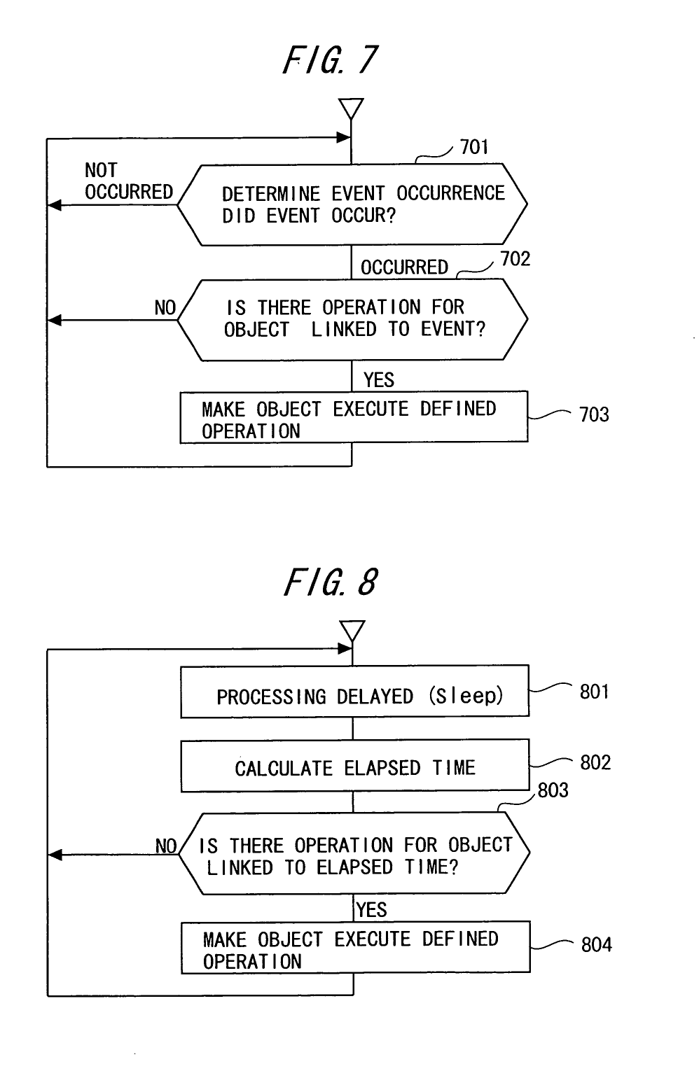

FIG. 7 is a flow chart showing object operation processing in the case where an event such as a mouse click is detected in the event monitoring module.

In other words, when the event such as the mouse click is detected (701), the event monitoring module detects whether or not there is an object linked to this event (702). Specifically, this is performed by referring to the object operation scenario definition table of the operation scenario (see FIG. 5).

Then, in a case where such an object exists, the object, for example, animation illustrating the procedure of a drawing process, is run in the multi-layered laminate image to which the object is linked (703). At this time, each multi-layered laminate image is defined in a transparent color, so that running of the animation is not visually obstructed by another multi-layered laminate image. In other words, the process of applying the marker to the specific place in the HTML document or generating a circle for drawing attention is reproduced on the display device of the user terminal.

FIG. 8 is a flow chart of processing for running the object by the elapsed time monitoring module when the predetermined time duration has elapsed.

As shown in the same diagram, the elapsed time monitoring module monitors the elapse of the predetermined duration of time, and the elapse of this predetermined duration of time serves as a trigger to load the object that is linked to this (801 to 804). With respect to the elapse of the predetermined duration of time, for example, when a predetermined number of seconds elapses after the user performed a last input operation, the process of applying the marker to the specific place in the HTML document or generating the circle for urging attention is reproduced on the display device of the user terminal.

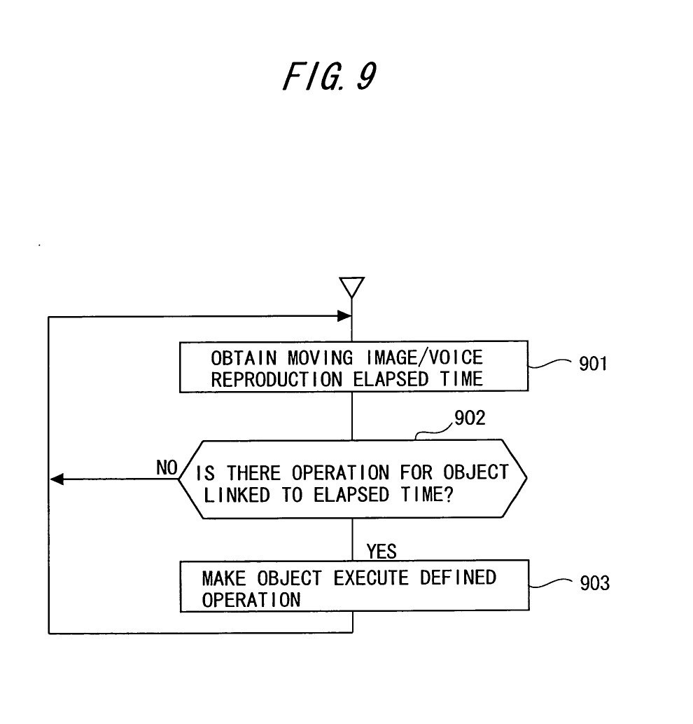

FIG. 9 is a flow chart of processing when the moving image/voice reproduction time monitoring module runs the object.

In the same diagram, the moving image/voice reproduction elapsed time is obtained (901), and in a case where there is an object which is linked to this (902), the object is loaded (903).

For example, this includes a case in which decoration is displayed on the HTML document in synchronization with the reproduction of the moving image.

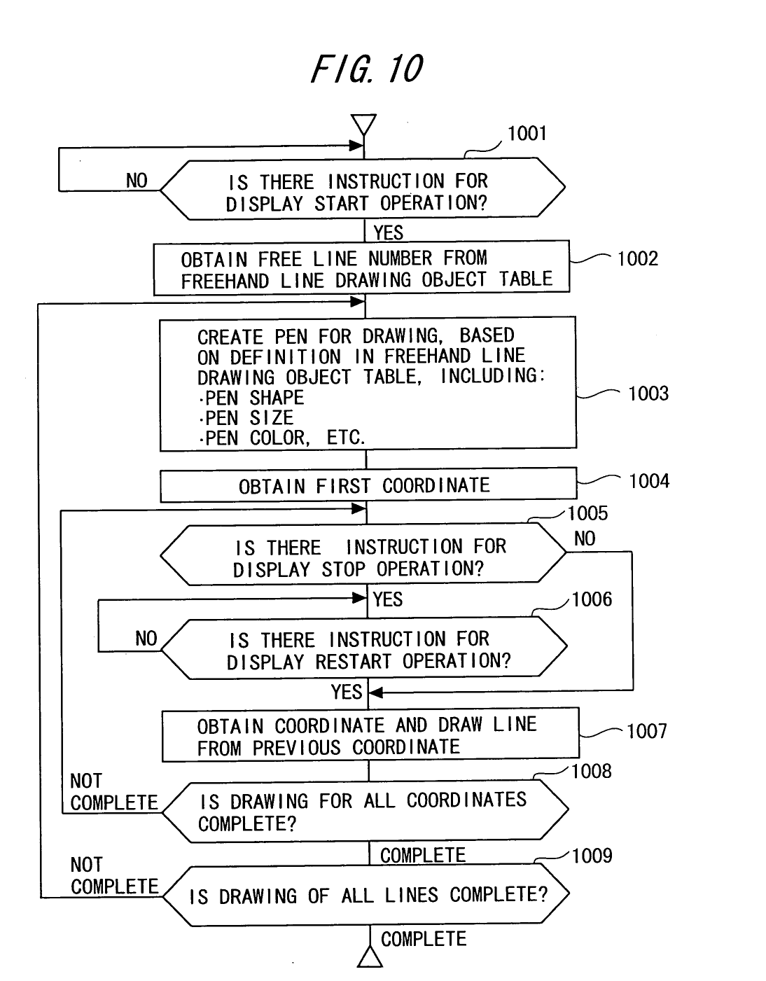

FIG. 10 is a flow chart of processing in a case where the object is the drawing processing.

In a case where the above-mentioned respective monitoring modules give an instruction for a display start operation (1001), the load module (the control module) obtains the number of the freehand lines from the freehand line drawing object storage table shown in FIG. 4 (1002).

Next, the freehand line drawing object storage table is referred to in a similar fashion, and the pen for drawing is defined based on definition items such as the pen shape, the pen size and the pen color (1003).

Next, the first coordinates are taken from the above-mentioned freehand line drawing object storage table (1004), and the drawing is repeated until there is obtained an instruction for an operation to show it (1005 to 1007). Then, when all the coordinates are drawn (1008), drawing by differently defined drawing pens is repeated, and when the drawing by all the drawing pens is completed the processing ends (1009).

According to this embodiment as described above, a high-visual-effect dynamic display can be achieved easily, without requiring complicated processing on a general-purpose information display screen.

As described above, to summarize this embodiment, at the content creation stage, the content creator reads the existing HTML document or the like or creates one anew, and arranges the objects while confirming them on the screen, without being aware of the above-mentioned laminate structure. At this time, the type, shape, display coordinates and the like of the arranged objects are stored in the object storage table.

Further, with the object which reproduces the process of the drawing on the transparent laminate, when the lines are freely drawn using the coordinate input device such as the mouse or the stylus pen, the drawings on the laminate are constantly stored into the freehand line drawing storage table, based on the inputted coordinates.

Further, in order that these objects effectively decorate the HTML document or other characters and the objects placed on the HTML document, etc., the content creator performs setting so that they appear, disappear, start operation, stop operation, and restart operation according to a duration of time elapsing after the HTML document is displayed, or according to reproduction time of the other objects having time axis, such as the moving image or voice, or in response to events such as the mouse click or mouse-in on the other arranged objects. All the scenarios which have been set are stored in the object operation definition table.

When the content creation is finished, the object storage table, the freehand line drawing storage table, the object operation definition table, etc., which have been stored as the tables, are stored as one operation scenario on the storage medium such as the hard disk.

At the time when the user is to view the content created in this way, the scenario stored in the storage medium such as the hard disk is automatically read, the object storage table, the freehand line drawing storage table, the object operation definition table and the like are opened up, and the reproduction is performed according to the content of these tables, whereby the content can be viewed as intended by the content creator.

Note that, explanation was made regarding the case where the drawing process is reproduced as an object. However, the present invention is not restricted to this. For example, reproduction of voice information, video information, and the like is also possible.

The technique of the present invention may be applied via the Internet to presentation using HTML document, and particularly to presentation at a remote place, and to an educational system or the like working via the Internet. In the case where the present invention is applied in the educational system, for example, when a student displays the HTML document on his/her own terminal and answers multiple-choice questions, input by the student serves as a trigger and a drawing process of displaying a circle or the like around the correct answer is reproduced as an object, whereby it is possible to increase the visual effect when the correct answer is displayed for the student.

Industrial Applicability

The present invention can be used for the presentation on the personal computer. Further, it can also be used in a field of educational authoring software.

1. A display control method comprising:
a step of displaying original display information displayed on a display device;
a step of reading, from a storage device, decorative operation information for decorating the original display information;
a step of reading, from the storage device, an object to be executed in multiple forms with respect to the original display information;
a step of reading, from the storage device, multi-layered image position information to be linked to the decorative operation information and to be layered on the original display information; and
a step of executing the read object at an image position stipulated by the multi-layered image position information, in accordance with the decorative operation information.

2. A display control method according to claim 1, wherein:
the original display information comprises an HTML document and the object comprises a drawing process of being displayed in multiple forms with respect to the HTML document, which are used to reproduce the drawing process multiplexed on the HTML document.

3. A computer readable recording medium recording a program for sequentially executing:
a step of displaying original display information displayed on a display device;
a step of reading, from a storage device, decorative operation information for decorating the original display information;
a step of reading, from the storage device, an object to be executed in multiple forms with respect to the original display information;
a step of reading, from the storage device, multi-layered image position information to be linked to the decorative operation information and to be layered on the original display information; and
a step of executing the read object at an image position stipulated by the multi-layered image position information, in accordance with the decorative operation information.

4. A program for executing:
a procedure of displaying original display information displayed on a display device;
a procedure of reading, from a storage device, decorative operation information for decorating the original display information;
a procedure of reading, from the storage device, an object to be executed in multiple forms with respect to the original display information;
a procedure of reading, from the storage device, multi-layered image position information to be linked to the decorative operation information and to be layered on the original display information; and
a procedure of executing the read object at an image position stipulated by the multi-layered image position information, in accordance with the decorative operation information.

5. An information display device comprising:
a display device for displaying at least original display information;
original display information storage means for storing the original display information;
decorative operation information storage means for storing decorative operation information for the original display information;
object storage means for storing an object to be executed in multiple forms with respect to the original display information;
multi-layered image position information storage means for storing multi-layered image position information to be linked to the decorative operation information and to be layered on the original display information; and
display control means for executing the read object at an image position stipulated by the multi-layered image position information on the display device, in accordance with the decorative operation information.
